(19) United States
(12) Patent Application Publication
(10) Pub. No.: US 2005/0142262 A1
(43) Pub. Date: Jun. 30, 2005

(54) Method for formation of puffed cereal cakes

(76) Inventors: Lamar Johnson, Carver, MN (US); Chris Willoughby, Battle Creek, MI (US); Michael N. Bauman, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/994,697

(22) Filed: Nov. 22, 2004

Related U.S. Application Data
(60) Provisional application No. 60/524,285, filed on Nov. 21, 2003.

(51) Int. Cl. A21D 2/00

(52) U.S. Cl. 426/440

(57) ABSTRACT

A method for forming a puffed cereal cake is disclosed. The method includes pre-treating the grain used to make the cake by flash frying it in a flash frying media for a period of time of from 1 to 15 seconds prior to puffing and forming the cake. Preferred flash fry media include an edible oil, shortening, or paraffin at a temperature of from 145 to 205° C. Alternatively, the media can comprise a caustic bath of 1% baking soda and 99% water at a temperature of from 70 to 85° C. The pretreatment allows the formation of a puffed cereal cake with dramatically improved taste and texture. In addition, the pre-treatment permits coatings of seasonings or flavorants to adhere to the puffed cereal cake much better. The puffed cereal cake can have a desirable high fat taste with out actually being a high fat food.

### RELATED APPLICATIONS

This application claims the benefit of U.S. Provisional Application No. 60/524,285, filed Nov. 21, 2003.

### STATEMENT REGARDING FEDERALLY SPONSORED RESEARCH

NONE

### TECHNICAL FIELD

This invention relates generally to formation of puffed cereal cakes commonly known as rice cakes and, more particularly, to a method for formation of puffed cereal cakes having enhanced organoleptic qualities.

### BACKGROUND OF THE INVENTION

Snack foods have long been popular in households worldwide. Typically, these have included potato chips, pretzels, snack crackers, corn chips, candies, and ice creams. Current health conscious trends have been moving consumers to seek “healthier” snack products. Increasingly, attractive snack foods to consumers have been lower in fat or no fat food products. One especially popular category of snack foods have been puffed cereal cakes also known as rice cakes.

These puffed cereal cakes have typically been formed from either puffed corn or puffed rice. They can, however, be formed from a wide variety of grains including barley, buckwheat, corn, millet, wheat, oat, rice, rye, sorghum, or combinations of these grains. Typically the cakes are formed from whole grains, cut whole grains, or whole grains that have been milled or pearled to remove the outer bran layer. In execution the grains are formed in a cereal cake puffing machine using essentially only the grain. Sometimes a small amount of starch or flour is added to add in the molding and puffing process. In some forms the cakes are seasoned after formation. Because of the many documented benefits of eating whole grains rice cakes would seem to be an ideal healthy snack food. In addition to whole grains the rice cakes can be a significant source of fiber, which has additional health benefits, depending on how the grains are treated. Consumers have found the healthy benefits of rice cakes to be appealing. As a result rice cakes initially became a very popular snack food. Consumers became disillusioned with rice cakes despite their health benefits because of their generally unpleasant texture and taste. Traditionally rice cakes have been very dry and have been described as having a styrofoam or cardboard taste. Attempts to address these organoleptic perceptions have largely unsuccessful. Attempts to coat the rice cakes with seasonings to improve their taste have not worked because most coating materials do not adhere well to the puffed cereal cakes. Thus, sales of these healthy snack foods have lagged.

It would be beneficial to develop a method for forming a puffed cereal cake that addresses the negative organoleptic perceptions while retaining the healthy benefits associate with their consumption. These perceptions could be overcome by developing a method that would improve their texture and ability to hold seasonings.

### SUMMARY OF THE INVENTION

In general terms, this invention provides a puffed cereal cake having improved organoleptic properties and seasoning retention properties. The improved organoleptic properties include a crisper more appealing texture and a better mouth feel compared to traditional cereal cakes. The cakes prepared according to the present invention taste like an appealing higher fat food product while remaining a low fat product. In addition, the improved seasoning retention opens up new possibilities for creating novel tasting experiences for consumers.

In one embodiment, the present invention is a method of forming a puffed cereal cake comprising the steps of: providing a grain; flash frying the grain in a flash frying media for a period of time of from 1 to 15 seconds; placing the flash fried grain into a mold; and puffing the flash fried grain in the mold under pressure to form a puffed cereal cake. In another embodiment, the present invention is a puffed cereal cake comprising a grain that has been pretreated by flash frying for a period of from 1 to 15 seconds.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIGURE 1 is flow chart of the method according to the present invention

### DETAILED DESCRIPTION OF A PREFERRED EMBODIMENT

As discussed above puffed cereal cakes can be formed from a wide variety of grains including barley, buckwheat, corn, millet, wheat, oat, rice, rye, sorghum, or combinations of these grains. Puffed cereal cakes may also include food starches and flours to improve their puffability and molding characteristics in rice cake forming machines. Because these cakes have traditionally been formed from rice they are referred to a rice cakes and the presses used to form them are known in the art as rice cake machines; however they can be formed on these machines using any of the grains noted above. The grains used can be in a variety of forms. The grains can be used in their native whole form. The grains can be whole grain that has been cut to smaller sizes such as degermed grits. The grains can also be pretreated by milling or pearling to remove all or most of the outer bran layer. In what ever form they are used the grains are typically raw and uncooked when used to form the puffed cereal cakes.

Rice cake forming machines are well known in the art and their operation will only be briefly described. They are also known as grain popping machines and are available from many manufacturers including Real Foods Pty, Ltd. of St Peters NSW, Australia. The grain is equalized to a moisture level of from about 8 to 20% by weight, more preferably 11 to 18%. The grain is loaded into a feed bin of the rice cake forming machine. The feed bin meters the appropriate amount of grain into a mold. The mold typically has a stationary heated lower platen mold half and a heated upper platen having a reciprocally movable piston. After the grain has been deposited in the lower platen mold half the upper platen is lowered and its piston compresses the grains in the mold. The platens are typically heated to a temperature of from about 170 to 320° C., more preferably to 200 to 300° C. The piston initially applies a pressure of from about 3 to 15 MPa (30 to 150 bars), more preferably from 4 to 10 MPa (40 to 100 bars). The grains are typically compressed and heated for about 1 to 20 seconds and then the piston is rapidly retracted a distance of from about 3 to 25 millimeters to decrease the pressure and puff the grains. The puffed grains fill the expanded mold and bond to each other. The puffed cake is then removed from the mold. A typical final moisture of the cake is from about 2 to 10% by weight, more preferably from 3 to 6%. The cakes are cooled and then packaged. The cooled cakes are also sometimes dusted or sprayed with seasonings, although these have not adhered well in past attempts. If the coating is sprayed it may be necessary to dry the coated cakes down to the desired moisture prior to packaging.

The present inventors have found that a unique pretreatment of the grain in what ever form it is used results in a puffed cereal cake that has improved organoleptic properties and seasoning retention properties. In addition the texture of the puffed cereal cake is very improved. The unique pretreatment is a short duration flash frying of the grain prior to it being loaded into the feed bin. The grain is flash fried in a flash fry media for a period of time of from 1 to 15 seconds, more preferably for 1 to 10 seconds, and most preferably for 1 to 5 seconds. In one embodiment the flash frying media is any edible oil such as a vegetable oil or a shortening, or it can be a paraffin. Preferably these media are at a temperature of from 145 to 205° C., more preferably at a temperature of from 180 to 195° C. An alternative flash fry media comprises a heated caustic bath, preferably of 1% by weight baking soda and 99% by weight water, at a temperature of from about 70 to 85° C. The flash fried grain is then removed from the frying media, excess frying media is removed and the grain is cooled. Exposing the grain to the flash frying media causes the grain to develop porosity and tackiness in the outer layer. This outer layer of porosity and tackiness is beneficial in enhancing the ability of coatings to adhere to the grain and the formed puffed cereal cake. The flash fried grain can be treated with a coating material as described below while still hot. The cooled flash fried grain, whether coated or not, is then processed as usual in a puffed cereal cake machine.

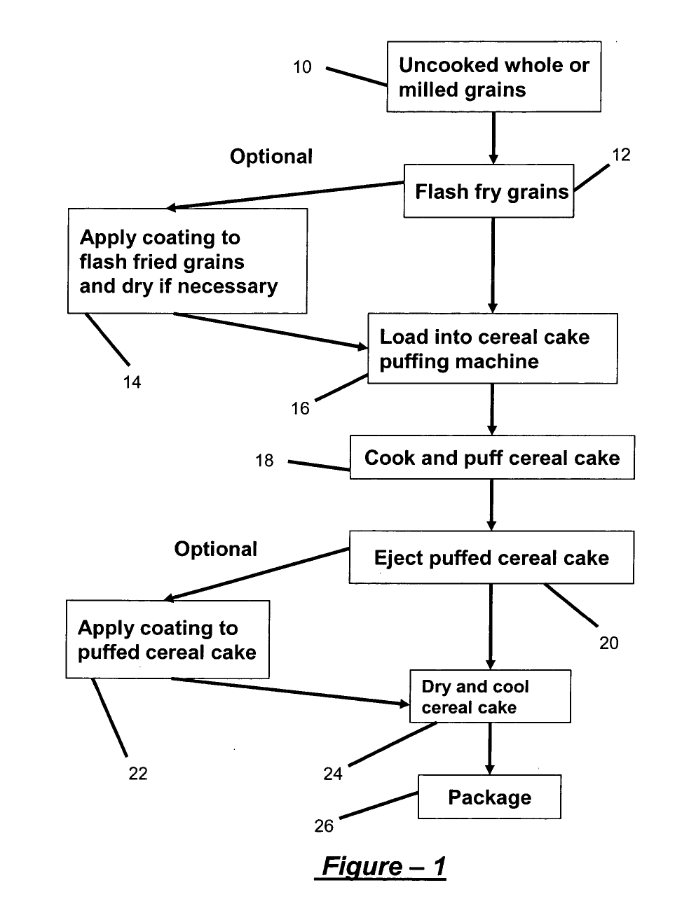

FIGURE 1 is a flowchart of the method as described in the present invention. In step 10 the uncooked grain is prepared at the proper moisture as described above. In step 12 the grain is flash fried as described. In optional step 14 the flash fried grain, preferably while still hot, is coated with any of a variety of coating materials. Preferably the coatings are seasonings, flavorants, vitamins, minerals, or combinations thereof. The coatings can include virtually any seasoning or flavorant. Some examples include salt, garlic, herbs, natural or artificial flavorings, cheese powder, chili powder, pepper, natural sweeteners, artificial sweeteners, hot peppers, savory seasonings, fruit powders, vegetable powders, vitamins, minerals, or combinations thereof. The coating can be applied in any known in the art manner. Some examples include a liquid spray system, a liquid spray followed by a dry dusting, dipping, dusting, or a rotary coating drum. One advantage of applying the coating at this point is that the flavor and seasonings are ensured to be throughout the entire puffed cereal cake. The coating is also less likely to be messy and get on the hands of a consumer. If a coating is applied using a liquid it may be necessary to dry the coated grains to the desirable moisture level of from 8 to 20% as noted above. The cooled flash fried grain, coated or not, is then loaded into the puffed cereal cake forming machine in step 16. At this point a starch or flour can be added to the grains as is known in the art to improve the molding and puffing. The loaded grain is then cooked and puffed in the machine in step 18. The cooked puffed cereal cake is then ejected in step 20. After step 20 another optional step 22 is to coat the puffed cereal cake either for the first time or a second time. The coating can be the same as or different from the first coating. The coating materials and methods are as described above. It can be beneficial to coat with the vitamins and minerals at this point if desired because there are no further very high temperature steps in the process. When the coating is applied using a liquid it may be necessary to dry the cereal cake down to the desired moisture content of 2 to 10% by weight as discussed above prior to cooling as shown in step 24. In step 26 the puffed cereal cakes are packaged for distribution to consumers.

Puffed cereal cakes prepared according to the present invention have numerous benefits. The texture of the puffed cereal cakes is improved compared to typical cereal cakes. They have improved crispness and mouth feel. When the flash fry media used on the grain is an edible oil the cereal cake has a desirable higher fat taste while remaining a low fat product. Consumers find this improved taste to be highly desirable. For example typical microwave popcorn has a fat content of over 50% by weight. Because of the short exposure and high temperature of the media the actual fat level in the present invention is not increased greatly. In addition, the pleasing taste is distributed through out the entire cake. Typically, the present invention brings the fat content to from 5 to 20%. This compares to topical use of oil to hold seasonings as in the prior art, which can bring the fat level to 10 to 30% by weight. Another benefit of the present invention is that the puffed cereal cake has much higher coating retention properties. Coatings adhere within and around the grains and the taste is perceived through out the entire cake. One theory is that the porosity and tackiness of the grains caused by the flash fry media is responsible for the improved seasoning retention properties.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A method of forming a puffed cereal cake comprising the steps of:
a) providing a grain;
b) flash frying the grain in a flash frying media for a period of time of from 1 to 15 seconds;
c) placing the flash fried grain into a mold; and
d) puffing the flash fried grain in the mold under pressure to form a puffed cereal cake.

2. The method as recited in claim 1, wherein step a) comprises providing the grain as a whole grain, as grits, as a cut whole grain, as a milled grain, as a pearled grain, or as a combination thereof.

3. The method as recited in claim 1, wherein step a) comprises providing as the grain barley, buckwheat, corn, millet, wheat, oat, rice, rye, sorghum, or combinations thereof.

4. The method as recited in claim 1, wherein step b) comprises providing as the flash frying media one of an edible oil, a shortening, a paraffin, or a caustic bath.

5. The method as recited in claim 1, wherein step b) comprises flash frying the grain for a period of time of from 1 to 10 seconds.

6. The method as recited in claim 1, wherein step b) comprises flash frying the grain for a period of time of from 1 to 5 seconds.

7. The method as recited in a claim 1, wherein step b) comprises providing as the flash frying media one of an edible oil, a shortening, or a paraffin at a temperature of from 145 to 205° C.

8. The method as recited in a claim 1, wherein step b) comprises providing as the flash frying media a caustic bath at a temperature of from 70 to 85° C.

9. The method as recited in claim 8, wherein step b) comprises providing a caustic bath comprising 1% by weight baking soda and 99% by weight water.

10. The method as recited in claim 1, wherein step d) comprises providing the mold at a temperature of from about 170 to 320° C.

11. The method as recited in claim 1, wherein step d) comprises puffing the grain in a mold at a pressure of from 30 to 150 bars.

12. The method as recited in claim 1, wherein step d) comprises puffing the cereal cake for a period of time of from 1 to 20 seconds.

13. The method as recited in claim 1, further comprising after step b) and before step c) the step of coating the flash fried grain with a seasoning, a flavorant, a vitamin, a mineral, or a combination thereof.

14. The method as recited in claim 13, further comprising the step of drying the coated grain to a moisture content of from 8 to 20% by weight prior to step c).

15. The method as recited in claim 1, further comprising after step d) coating the puffed cereal cake with a seasoning, a flavorant, a vitamin, a mineral, or a combination thereof.

16. The method as recited in claim 15, further comprising the step of drying the puffed cereal cake after application of the coating to a moisture of from 2 to 10% by weight.

17. A puffed cereal cake made according to the method of claim 1.

18. A puffed cereal cake comprising a grain that has been pretreated by flash frying for a period of from 1 to 15 seconds.

19. The puffed cereal cake as recited in claim 18 further comprising a grain having a coating applied to the grain after the flash fry pretreatment.

20. The puffed cereal cake as recited in claim 19, wherein said coating is a seasoning, a flavorant, a vitamin, a mineral, or a combination thereof.

21. The puffed cereal cake as recited in claim 18 wherein said grain has been flash fried in a media at a temperature of from 145 to 205° C. and wherein said media comprises an edible oil, a shortening, or paraffin.

22. The puffed cereal cake as recited in claim 18 wherein said grain has been flash fried in a media at a temperature of from 70 to 85° C. and wherein said media comprises a caustic bath of 1% by weight baking soda and 99% by weight water.

23. The puffed cereal cake as recited in claim 18, wherein said grain comprises barley, buckwheat, corn, millet, wheat, oat, rice, rye, sorghum, or combinations thereof.

24. The puffed cereal cake as recited in claim 18, wherein said grain is a whole grain, a grit, a cut whole grain, a milled grain, a pearled grain, or a combination thereof.

25. The puffed cereal cake as recited in claim 18 wherein said cereal grain has been pretreated by flash frying for a period of from 1 to 10 seconds.
